(19) United States
(12) Patent Application Publication
(10) Pub. No.: US 2024/0416627 A1
(43) Pub. Date: Dec. 19, 2024

(54) METHOD OF PRODUCING A VENEERED BUILDING PANEL AND A VENEERED BUILDING PANEL

(71) Applicant: Välinge Innovation AB, Viken (SE)

(72) Inventors: Daniel SCIALANGA, HELSINGBORG (SE); Göran ZIEGLER, VIKEN (SE); Rickard RITTINGE, FÖRSLÖV (SE); Frederik SAND, HELSINGBORG (DE)

(73) Assignee: Välinge Innovation AB, Viken (SE)

(21) Appl. No.: 18/741,549

(22) Filed: Jun. 12, 2024

(30) Foreign Application Priority Data
Jun. 15, 2023 (SE) 2350735-3

(51) Int. Cl. B32B 21/14; B32B 7/12; B32B 21/02; B32B 21/08; B32B 21/13; B32B 27/36; B32B 37/06; B32B 37/10; B32B 37/18

(52) U.S. Cl. CPC B32B 21/14; B32B 7/12; B32B 21/02; B32B 21/08; B32B 21/13; B32B 27/36; B32B 37/06; B32B 37/10; B32B 37/18; B32B 2255/08; B32B 2255/26; B32B 2307/7246; B32B 2310/0825; B32B 2317/16; B32B 2607/00

(57) ABSTRACT

A method for producing a veneered building panel is provided. The method comprising: providing a substrate (1), applying a sub-layer (2) comprising a no added formaldehyde (NAF) binder on a first surface (4) of the substrate (1), applying a wood veneer layer (3) on the sub-layer (2), and applying heat and pressure to form said veneered building panel. The method further comprises dehydrating the wood veneer layer (3), prior to applying heat and pressure to form said veneered building panel, wherein dehydrating the wood veneer layer (3) comprises one or more of applying IR radiation, heat, microwaves and/or hot air to the wood veneer layer (3).

### CROSS REFERENCE TO RELATED APPLICATIONS

The present application claims the benefit of Swedish Application No. 2350735-3, filed on Jun. 15, 2023. The entire contents of Swedish Application No. 2350735-3 are hereby incorporated herein by reference in their entirety.

### TECHNICAL FIELD

The present invention relates to a method of producing a veneered building panel, such veneered building panel and a building panel.

### TECHNICAL BACKGROUND

Floor coverings having a wooden surface may be of several different types. Solid wood flooring is formed of a solid piece of wood in the form of a plank. Engineered wood flooring is formed of a surface layer of wood glued to a core. The core may be a lamella core or a wood-based panel such as plywood, MDF or HDF. The wooden surface layer may as an example have a thickness of 2-10 mm.

A wooden floor covering may also be formed by gluing a wood veneer to a core, for example, a wood-based panel such as particleboard, MDF or HDF. Wood veneer is a thin wood layer, for example having a thickness of 0.2-1 mm. A flooring with a separate surface layer glued to a core of for example HDF or plywood is more moisture stable than solid wood floorings.

Compared to solid wood and engineered wood floorings, wood veneer floorings can be produced at a lower cost since only a thin wood layer is used. However, a wood veneer layer cannot be sanded as a solid wood or engineered wood flooring can be.

In WO 2009/065769 a flooring and a process for manufacturing the flooring are described, where a substantially homogenous powder mix of fibres, binders and wear resistant particles, referred to as WFF (Wood Fibre Floor), is applied on a wood-based panel such as MDF or HDF. A thin surface layer, such as a wood veneer layer, is applied on the wood-based powder layer. The veneer layer is laminated to the wood-based panel under heat and pressure.

The binder of the powder mix described in WO 2009/065769 is e.g., a formaldehyde-based binder, e.g., a melamine formaldehyde-based binder. A problem is that both formaldehyde and melamine are harmful. Thus, a NAF binder, i.e., a no added formaldehyde binder, alternative would be desirable.

An alternative binder would e.g., be thermoplastic or thermoset polymers such as polyurethanes, acrylates, polyesters, or combinations thereof, possibly with a curing component. However, by using this type of binders in the manufacturing process described above, blistering and/or crack formation in the veneer layer may occur during pressing due to a combination of naturally occurring moisture content in the veneer and the degree of moisture permeability of the binder.

The presence of blisters and cracks is undesired both from an aesthetic perspective, and technically as inferior adhesion between the veneer layer and the core may occur.

From the above it is understood that there is room for improvements and the invention aims to solve or at least mitigate the above and other problems.

### SUMMARY

It is an object of at least embodiments of the present invention to provide an improvement over the above described techniques and known art.

Another object of at least embodiments of the present invention is to provide an improved method for producing a veneered building panel and such a veneered building panel including no added formaldehyde (NAF) binder.

In a first aspect, a method for producing a veneered building panel is provided. The method comprises providing a substrate, applying a sub-layer comprising a no added formaldehyde (NAF) binder on a first surface of the substrate, applying a wood veneer layer on the sub-layer, and applying heat and pressure to form said veneered building panel. The method further comprises dehydrating the wood veneer layer, prior to applying heat and pressure to form said veneered building panel, wherein dehydrating the wood veneer layer comprises one or more of applying IR radiation, heat, microwaves and/or hot air to the wood veneer layer. The method may comprise dehydrating the wood veneer layer after applying the wood veneer layer on the sub-layer.

A no added formaldehyde (NAF) binder is defined as a binder to which no formaldehyde or formaldehyde-containing composition has been added. However, as formaldehyde is found naturally in every living system, from plants to animals and humans, there may be trace amounts of formaldehyde present also in a NAF binder. Such trace amounts may be less than 0.5 wt. %, such as less than 0.1 wt. % or such as less than 0.01 wt. %.

In an embodiment the sub-layer comprises a binder including e.g., polyester, PVC, polyurethane or combinations thereof, which is free from added formaldehyde. However, these types of binders may result in a problem where blisters are formed in the wood veneer layer during the step of applying heat and pressure to the substrate/wood veneer layer, i.e., when forming the veneered building panel. This problem arises due to moisture in the wood veneer layer and the inability of such binders to take care of the moisture. The wood in the wood veneer layer naturally comprises a certain degree of moisture. The amount of moisture differs between different types of wood.

The moisture in the wood veneer layer in combination with the sub-layer being non-permeable to moisture, or having a low moisture permeability, means that the moisture cannot be transferred into the substrate, but instead forms blisters in the wood veneer of the veneered building panel. Thus, it is an object to provide a production method in which the formation of blisters is reduced.

The above object is achieved by the step of dehydrating the wood veneer layer prior to applying heat and pressure to the wood veneer layer. Thus, the blister formation is reduced compared to known production methods. This method is applicable to all sub-layers being non-permeable to moisture or having a low moisture permeability. Such sub-layers, as explained above, may comprise binders including e.g., polyester, PVC, polyurethane, polyolefins such as polyethylene (PE), polypropylene (PP), or a combination thereof.

If moisture is removed from the wood veneer to a moisture level below the natural amount of moisture, the wood will, in natural surroundings, rehydrate and absorb moisture from the surrounding environment again, until it regains its natural moisture content.

Therefore, if the wood veneer layer is dehydrated in a process separate from the production process of the veneered building panel, it may preferably be stored in a climate chamber or similar, in which the air is kept at a certain low humidity level. It may preferably also be transported into the production process of the veneered element in a low humidity environment, in order not to rehydrate during the transport.

Thus, the dehydration may be performed separately from the production of the veneered building panel if the surrounding environmental conditions fulfill certain humidity criterium. The humidity criterium differs between types of woods, and their natural amount of moisture.

Alternatively, the dehydration may be performed separately, but in connection with the production of the veneered building panel. For example, a robot configured to transport the wood veneer layer to the production process may drive through a heated area such as a dehydration room/chamber, climate room/chamber, a heating room/chamber or similar.

A picking station, where the wood veneer layer is picked up for transport to the production of the veneered building panel may be equipped with heating means or dehydration means.

Alternatively, the dehydration may be performed in-line with the production of the veneered building panel. That is, the dehydration may be performed at the same time as the other process steps. The dehydration may be performed after applying the wood veneer layer on the sub-layer.

The veneered building panel may preferably be a floor panel, a wall panel, a furniture component or similar.

The step of dehydrating the wood veneer layer may comprise one or more of applying IR radiation, heat, microwaves and/or hot air to the wood veneer layer.

The sub-layer may comprise a NAF binder.

The binder being a NAF binder is advantageous in that formaldehyde and melamine are both under legislative push.

The binder may be a thermoplastic binder or a thermosetting binder.

The binder may comprise one or more of PVC, polyester, polyurethane, or a combination thereof. A binder comprising one or more of these materials are advantageous in that no formaldehyde is required.

The sub-layer may be applied in powder form, as a sheet, in liquid form and/or as granulates.

The sub-layer may be applied as a sheet. Preferably, the sub-layer may be a resin impregnated sheet, or a film or foil made from a suitable NAF binder.

The sub-layer may comprise wood fibers, optionally recycled wood or wood waste.

The sub-layer may be applied in powder form.

The sub-layer may be applied in liquid form.

The sub-layer may be applied as granulates.

The method may further comprise heating the sub-layer prior to applying the wood veneer layer to the sub-layer. Depending on the type and composition of the sub-layer, this may be beneficial and contribute to adhering the sub-layer to the substrate, which may result in a more reliable process.

The step of heating the sub-layer may comprise applying IR radiation, heat, microwaves, and/or hot air on the sub-layer. By applying heat, e.g., in the form of IR radiation, the binder of the sub-layer applied in powder form may be transformed into fluid form, or at least sintered so the particles in the powder stick together. The binder melts when applying heat exceeding the melting point of the binder, resulting in improved adhering of the sub-layer to the substrate. Another advantage is that the risk of the binder in powder form “blows away” after being applied to the substrate is decreased.

If a thermosetting binder, the sub-layer is preferably not completely cured during the step of applying heat. It may be heated enough to form a film. The adhesive property of the sub-layer remains after the step heating the sub-layer.

Further, the sub-layer may be exposed through twig openings, cracks, slits and other open features in the wood veneer layer. When the wood veneer layer has been applied on the sub-layer and is subjected to heat and pressure in the subsequent pressing process the sub-layer will penetrate into, and to some level fill such open features. Thus, the sub-layer may be designed to match the design of the wood veneer layer or the edges of the open features. For example, the sub-layer may be given a colour design to match by including a pigment or dye in the sub-layer.

However, there may occur an issue if the sub-layer penetrates through the open features of and all the way through the wood veneer layer in that the sub-layer exposed in the open features of the wood veneer layer may abut and stick to pressing means of a pressing device such as a press plate or a press belt. The sub-layer is supposed to harden/cure and attach the wood veneer layer to the substrate during the pressing and heating but, the exposed portions of the sub-layer is not curing against the wood veneer layer, but is directly exposed, through the open features of the wood veneer layer, to the press plate/belt and cures against the press plate/belt. This may cause an outage/stoppage in the production line, since the sub-layer cured to the pressing device must be removed, and the pressing plate/belt cleaned.

A production stop is expensive and time consuming. It also requires manual work to remove the hardened sub-layer from the pressing device. However, in some applications, for example, when using thermoset polymers in the sub-layer, the step of dehydrating the wood veneer layer after being applied on the sub-layer, the sub-layer exposed in the open features of the wood veneer layer may be hardened/cured enough by the dehydrating process, not to adhere to the pressing device in the subsequent pressing step. It is only the sub-layer exposed in the open features of the wood veneer layer that is cured in the dehydration step. The sub-layer located below the veneer layer is not affected by the dehydrating process but retains its adhesive properties in order to attach the wood veneer layer to the substrate during the pressing. This is especially advantageous when the binder is a thermoset binder.

In other cases, for example, when using thermoplastic polymers in the sub-layer, an additional step of cooling the substrate, sub-layer and wood veneer layer prior to pressing to form the veneered building panel, may be beneficial in order to prevent such sub-layer in open features of the wood veneer layer from sticking to press means.

Another way of solving this issue may be to use a release foil during pressing in between the press means and the wood veneer layer and sub-layer (in the open features).

Applying the wood veneer layer on the sub-layer may follow upon the step of applying the sub-layer on the substrate without any intermediate steps. Thus, there may be no step of heating the sub-layer between applying the sub-layer to the substrate and applying the wood veneer layer on the sub-layer. For example, the step of dehydrating the wood veneer layer may occur before applying the wood veneer layer on the sub-layer. This is preferred when the sub-layer is applied in liquid form.

Dehydrating the wood veneer layer may comprise dehydrating the wood veneer layer to have a moisture content of less than 7 wt. %, or less than 5 wt. %. In an embodiment the wood veneer layer may be dehydrated to have a moisture content between 1 and 7 wt. %, or between 1 and 5 wt. %.

The moisture content of the wood veneer layer is defined as (m−m_{dry})/m*100 wt. %, where “m” is defined as the weight of the sample to be dried and “m_{dry}” is defined as the weight of the sample after the dehydration process.

The moisture content of the wood veneer layer may be determined by a gravimetric method by weighing the wood veneer layer before and after dehydration in an oven. For example, the wood veneer layer is placed in the oven at 103° C. for 8 h.

The method may further comprise a step of measuring a moisture content of the wood veneer layer prior to the step of dehydrating said wood veneer layer. It may additionally and/or alternatively comprise a step of measuring the moisture content of the wood veneer layer after the step of dehydrating said wood veneer layer.

By measuring the moisture content of the wood veneer layer, it is possible to optimize the dehydration of said wood veneer layer by adjusting the dehydration time and/or the dehydration temperature in accordance with the measured moisture content. Optionally, the moisture content is measured continuously during the dehydration of said wood veneer layer.

The substrate may be a wood-based board. Optionally, the substrate may be an MDF board, a HDF board, a particle board or any other suitable wood-based board.

An applied dehydration effect, for dehydrating the wood veneer layer, may be proportional to a thickness of the wood veneer layer.

The method may further comprise applying a back side layer arrangement comprising a backing layer to a second surface of the substrate opposite the first surface on which the sub-layer is applied.

The backing layer may comprise one of a lacquer, a varnish, an adhesive, a polymer-based sheet or foil, impregnated paper or unimpregnated paper, a (coloured) powder layer or a fabric, such as a woven or non-woven fabric.

Known veneered building panels, produced with a sub-layer comprising melamine formaldehyde resin, require a balancing layer provided on a surface of the substrate being opposite the surface on which the sub-layer and wood veneer layer is provided. The melamine formaldehyde results in shrinkage, or pulling, forces acting on the veneered building panel. Without the balancing layer, the product may be “cupping,” i.e., a first surface of the panel will shrink, the opposite surface will stretch correspondingly, resulting in a building panel with a concave cross section. Thus, a balancing layer is required to stabilize and/or balance the veneered building panel in order to counteract those types of forces.

In order to provide balance, the balancing layer may preferably comprise the same layers as provided on the opposite side of the substrate, at least preferably comprise the same binder as provided on the opposite side of the substrate. Providing a balancing layer to the veneered building panel makes the production more expensive. This is both due to material costs, but also a more complicated production process with an additional step of providing, handling, and storing the balancing layer.

According to the method described herein, based on a binder not comprising formaldehyde, there may not be a need for such a balancing layer. Possible pulling forces due to the sub-layer may be too small to require balance in the form of a balancing layer.

There may however still be provided an optional backing layer, comprising e.g., a thin layer such as a lacquer, a varnish, an adhesive, a polymer-based sheet or foil, an impregnated paper or unimpregnated paper, a (coloured) powder layer or a fabric, such as a woven or non-woven fabric.

The backing layer may be provided for informational, aesthetic, or decorative purposes.

The back side layer arrangement and the backing layer may be configured to form a moisture barrier. This is advantageous when the veneered building panel is used as a floor panel and/or a building panel. Moisture from the base or foundation, such as a concrete ground, on which the veneered building panel is applied may be transferred into the veneered building panel. This may cause swelling of the veneered building panel which may result in a deformed veneered building panel. If the amount of swelling differs between the first and second surfaces of the veneered building panel, the panel will be concave in cross section, i.e., the building panel will experience cupping. By applying e.g., a backing layer forming a moisture barrier, the transfer of moisture into the veneered building panel causing swelling is limited. A backing layer configured to form a moisture barrier may comprise e.g. a thin layer such as a lacquer, a varnish, an adhesive, a polymer-based sheet or foil, an impregnated paper or a (coloured) powder layer.

The back side layer arrangement may further include a binder configured to attach the backing layer to the second surface of the substrate.

The binder may be different from the binder in the sub-layer.

The binder may be the same as the binder in the sub-layer.

The step of pressing may be performed by a continuous press.

The step of dehydrating the wood veneer layer may be performed by means of heat from the continuous press. This is achieved by means of the cylinders as the wood veneer layer enters the continuous press. The cylinders give off radiant heat under which the wood veneer layer is dehydrated. The production properties such as the input speed of the wood veneer layer and the diameter of the cylinders will play a role during this dehydration process. The production properties are further dependent on e.g., the thickness of the wood veneer layer and which type of wood the wood veneer layer is made of.

The step of pressing may be performed by a static press.

The step of dehydrating the wood veneer layer may be performed by means of heat from the static press. This is achieved by lowering the press slowly or even stopping the downward motion of the press for a time period, such that the heat from the press dehydrates the wood veneer layer before pressure is applied by the press.

In a second aspect, a veneered building panel produced with the method according to the first aspect is provided.

In a third aspect, a veneered building panel is provided. The veneered building panel comprises a substrate, a front side layer arrangement and a back side layer arrangement. The front side layer arrangement is arranged on a first surface of the substrate and the front side layer arrangement comprises a sub-layer, and a wood veneer layer. The sub-layer is arranged between the substrate and the wood veneer layer. The back side layer arrangement is arranged on a second surface of the substrate opposite the front side layer arrangement and the back side layer arrangement comprises a backing layer. The sub-layer comprises a no added formaldehyde (NAF) binder and the back side layer arrangement is different from the front side layer arrangement.

This is advantageous since formaldehyde is known to be carcinogenic.

The binder may be a thermoplastic binder or a thermosetting binder.

The binder may comprise one or more of PVC, polyester, polyurethane or a combination thereof.

The sub-layer may further comprise wood fibers, optionally recycled wood or wood waste.

The sub-layer may during the method of producing such a veneered building panel be applied in powder form, or in liquid form, or in the form of a sheet.

The binder may be comprised in a resin impregnated sheet.

During the method of producing the veneered building panel the wood veneer layer may be dehydrated to have a moisture content of less than 7 wt. %, or less than 5 wt. %, before being attached to the sub-layer. In an embodiment the wood veneer layer may be dehydrated to have a moisture content between 1 and 7 wt. %, or between 1 and 5 wt. %. The wood veneer layer may be dehydrated to have a moisture content of less than 7 wt. %, or less than 5 wt. %, at the time of applying heat and pressure to form the veneered building panel. An applied dehydration effect, for dehydrating the wood veneer layer may be proportional to the thickness of the wood veneer layer. The dehydration effect may be varied by varying for example the applied effect, the application time and/or the applied temperature.

The substrate may be a wood-based board, optionally an MDF, HDF board, a particle board or any other type of wood-based board.

A thickness of the wood veneer layer may be 0.2-2.5 mm., or 0.3-2.0 mm.

The backing layer may comprise one of a lacquer, a varnish, an adhesive, a polymer-based sheet or foil, impregnated paper, or unimpregnated paper, a (coloured) powder layer or a fabric, such as a woven or non-woven fabric.

The backing layer may form a moisture barrier.

The back side layer arrangement may further include a binder configured to attach the backing layer to the substrate. The binder in the backing layer may be different from the binder in the sub-layer, or the binder in the back side layer arrangement may be the same as the binder in the sub-layer.

The veneered building panel may be a floor panel, a wall panel, a furniture component or similar.

### BRIEF DESCRIPTION OF THE DRAWINGS

The present invention will by way of example be described in more detail with reference to the appended schematic drawings, which show embodiments of the present invention.

FIG. 1 shows a method of producing a veneered building panel according to an embodiment of the present inventive concept,

FIG. 2 shows a method of producing a veneered building panel according to another embodiment of the present inventive concept,

FIG. 3 shows a method of producing a veneered building panel according to yet another embodiment of the present inventive concept,

FIG. 4 shows a method of producing a veneered building panel according to an embodiment of the present inventive concept,

FIG. 5 shows a method of producing a veneered building panel according to another embodiment of the present inventive concept,

FIG. 6 is a flowchart of a method of producing a veneered building panel,

FIG. 7 is an alternative flowchart of a method of producing a veneered building panel,

FIG. 8 is a veneered building panel according to an embodiment of the present inventive concept,

FIG. 9 is a veneered building panel according to another embodiment of the present inventive concept, and

FIG. 10 is a veneered building panel according to yet another embodiment of the present inventive concept.

Further, in the figures like reference characters designate like or corresponding parts throughout the several figures.

### DETAILED DESCRIPTION OF EMBODIMENTS

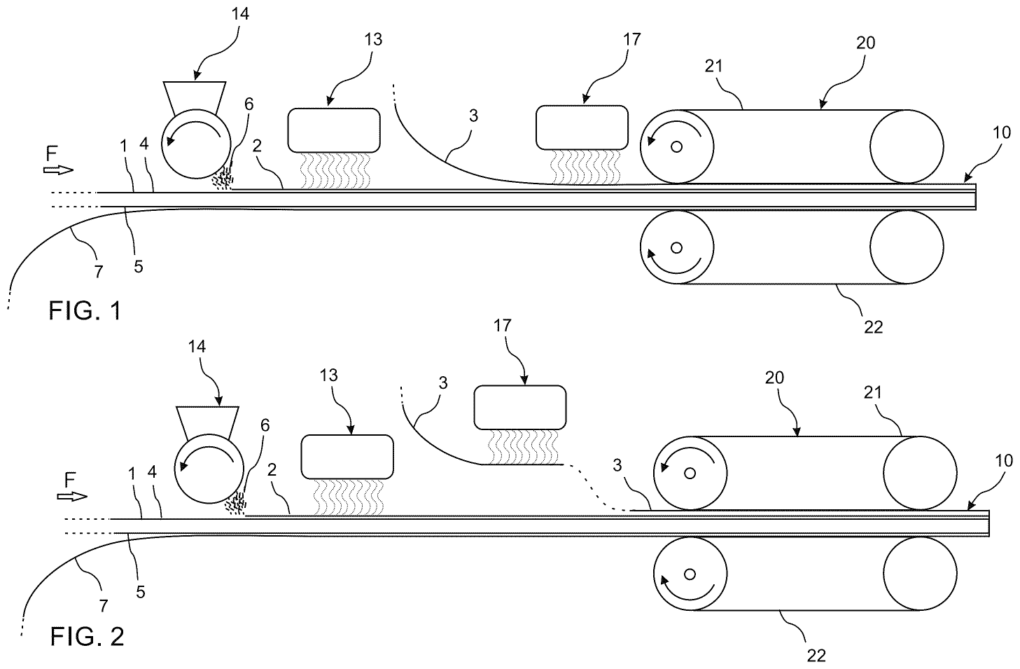

FIGS. 1-5 illustrate embodiments of a method for producing a veneered building panel 10. The veneered building panel 10 may be, or form part of, a furniture component, a building panel such as a floor panel, a ceiling panel, a wall panel, a door panel, a worktop, skirting boards, moldings, edging profiles, etc.

The method includes providing a substrate 1. The substrate 1 is moved in a direction F through a production line comprising several steps, which will be further described below.

The substrate 1 is preferably a prefabricated substrate, produced prior to the method of producing the panel 10. The substrate 1 may be a board, for example, a wood-based board. The wood-based board may be a wood fiber-based board such as MDF, HDF, particleboard, etc., or plywood. The substrate 1 may be a sheet of paper or non-woven. In other embodiments, the substrate 1 may be a Wood Plastic Composite (WPC). The substrate 1 may be a plastic board such as a thermoplastic board. The substrate 1 may be a mineral composite board. The substrate 1 may be a fibre cement board. The substrate 1 may be magnesium containing cement board. The substrate 1 may be a ceramic board.

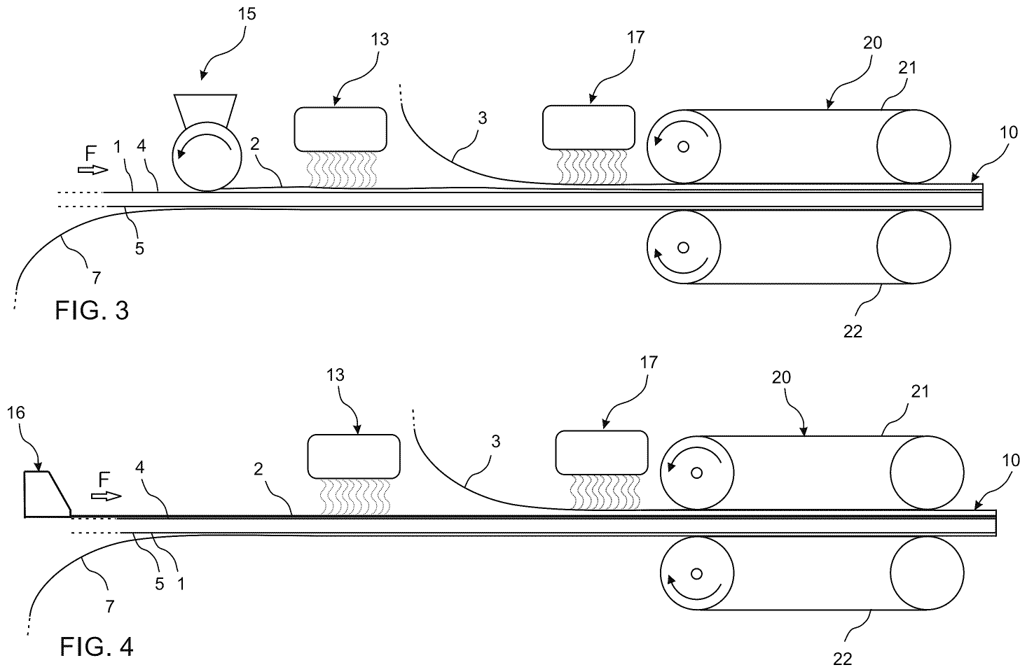

As shown in FIG. 1, a sub-layer 2 is applied on a first surface 4 of the substrate 1. In this embodiment, the sub-layer 2 is applied in powder form 6, preferably in dry powder form. The sub-layer 2 is applied by scattering by means of a scatter device 14. The sub-layer 2 may alternatively be applied as granules. In other embodiments, the sub-layer 2 may be applied as a liquid by, e.g., a roller coater device 15, as shown in FIG. 3, as a paste, a sheet, etc. The sub-layer 2 may be applied as an extruded sheet, extruded by means of an extruder 16 as shown in FIG. 4. The extrusion may be e.g., slot extrusion or bead extrusion. The sub-layer 2 may further be applied by spraying, etc.

The sub-layer 2 comprises a binder. In one embodiment, the sub-layer 2 comprises a binder and one or more additives and/or fillers. The sub-layer 2 may comprise one or more of wood fibers, mineral fibers, and inorganic fillers. Additives and fillers may be colourants, e.g., pigments or dyes, rheology modifiers or reinforcing materials.

The wood fibers are preferably made from recycled wood or wood waste. The recycled wood fibers may come from old used-up wood building panels such as furniture, flooring or building elements. The wood waste may come from various wood handling processes such as furniture, flooring, or building production processes.

The binder is a NAF (no added formaldehyde) binder. The binder may be a thermoplastic binder or a thermosetting binder. The thermoplastic binder may be polyvinylchloride (PVC), polyurethane (PU), polyethylene (PE), polypropylene (PP), polyvinyl alcohol (PVOH), polyvinyl butyral (PVB), and/or polyvinyl acetate (PVAc), or a combination thereof. The thermosetting binder may be polyurethane, polyester, emulsion polymer isocyanate (EPI), or a combination thereof.

The sub-layer 2 may be applied on the substrate 1 in form of a sheet or foil. The sheet may be impregnated with the binder. The sheet may be a paper sheet. The sheet may be a non-woven. The sheet may be coloured, and/or the binder used to impregnate the sheet may be coloured, such that sheet becomes coloured during impregnation.

The method may comprise a step of applying heat by means of a heating device 13 to the sub-layer 2. The heat may be applied by any suitable type of heat source e.g., thermal radiation, such as IR radiation, and/or by microwaves, and/or by hot air. IR radiation is preferred if the sub-layer 2 is applied in powder form. Other types of heat sources as presented above may be used if the sub-layer 2 is applied in sheet form. The preferred temperature, the heating effect and duration of the heating depends on the veneered building panel to be produced. It may e.g., depend on the heat source being used, the thickness of the wood veneer layer and/or sub-layer, the intended appearance or decorative effects of the veneered building panel, the type of binder used, etc. An exemplary surface temperature for a sub-layer surface may be 100° C. to 200° C. For example, IR radiation may be applied for 5-100 seconds, such as 5-60 seconds or 10-30 seconds, achieving a sub-layer surface temperature of 100° C. to 200° C.

The sub-layer may be heated without first applying moisture to the sub-layer.

The step of heating the sub-layer 2 serves to sinter particles of the binder in the sub-layer 2. For example, the sintered particles may form a contiguous mass. For example, the sintered particles of the sub-layer 2 may adhere to the substrate 1.

After applying the sub-layer 2 on the substrate 1 and, if conducted, heating the sub-layer 2, a wood veneer layer 3 is applied on the sub-layer 2.

The wood veneer layer 3 may have porous structure. Pores are formed by vessel elements of angiosperms such as hardwood being cut such that hollow channels are formed. Tracheids are formed by elongated cells in the xylem of gymnosperms such as softwood.

The wood veneer layer may also comprise open features such as holes and cracks.

The wood veneer layer 3 may have a thickness of about 0.2 to 2.5 mm., or 0.3 to 2.0 mm.

The wood veneer layer 3 may be continuous or non-continuous. The wood veneer layer 3 may be formed of several veneer pieces, i.e., being non-continuous. The veneer pieces may be over-lapping or non-overlapping.

In a similar manner as described above, the sub-layer 2 described above may be applied on a surface of the wood veneer layer 3 configured to face the substrate 1. Then, the wood veneer layer 3, with the sub-layer 2, may be applied on the first surface 4 of the substrate 1. The sub-layer 2 may be applied both on the substrate 1 and on the wood veneer layer 3.

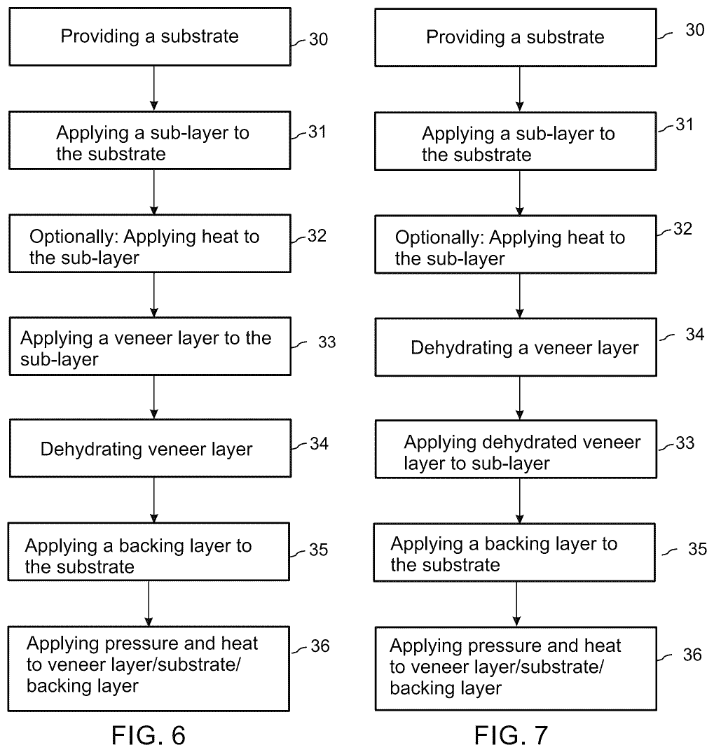

The method further comprises a step of dehydrating, or drying, the wood veneer layer 3 by means of a dehydration device 17. The dehydration of the wood veneer layer 3 may be performed prior to applying the wood veneer layer 3 on the sub-layer 2, as shown in FIG. 2, and in the flowchart of FIG. 7. Alternatively, and/or additionally, the dehydration of the wood veneer layer 3 may be performed after applying the wood veneer layer 3 on the sub-layer 2, as shown in FIGS. 1, 3-5, and in the flowchart of FIG. 6.

The dehydration of the wood veneer layer 3 comprises subjecting the wood veneer layer 3 to one or more of IR radiation, heat, microwaves, and/or hot air.

The IR radiation effect may be proportional to the thickness of the wood veneer layer 3. The IR lamp may be set on 10-100% of its maximum effect. The maximum effect of the IR lamp may for example be between 10 and 200 kW, such as between 25 and 100 kW.

The time during which the wood veneer layer 3 is subject to the dehydration may be proportional to the thickness of the wood veneer layer 3. The time during which the wood veneer layer 3 is subjected to dehydration may be adjusted by adjusting the speed at which the substrate/panel is passed below the IR lamp. The speed at which the substrate/panel is passed below the IR lamp may for example be 1-10 m/min, such as 5 m/min.

The method may further comprise measuring a moisture content of the wood veneer layer 3 prior to the dehydration of said wood veneer layer 3. The method may comprise a step of determining whether dehydration of the wood veneer layer 3 is required, and/or determining at which IR effect the dehydration is to be performed, and/or determining a duration of the dehydration.

The method may also, or alternatively, comprise a step of measuring the moisture content of the wood veneer layer 3 after the dehydration of the wood veneer layer 3. The method may, after the step of measuring the moisture content of the dehydrated wood veneer layer 3, comprise a step of determining whether further dehydration of the wood veneer layer 3 is required, and/or determining or adjusting the IR effect at which the dehydration is performed, and/or determining a further duration of the dehydration.

The wood veneer layer 3 naturally comprises a certain amount of moisture, which amount may differ between types of wood. Different types of wood may be differently prone to blistering or cracking. Wood veneer layers of different types of wood may thus be dehydrated to different moisture contents.

In an embodiment, at least 10 wt. %, such as at least 5 wt. %, or 2 wt. % of the moisture in a wood veneer is removed from the wood veneer by the dehydration process.

The dehydration process may start with a wood veneer with its natural amount of moisture. The natural amount of moisture for oak type of wood veneer may be 15-5_wt %, and for birch type of wood veneer may be 20-8 wt %.

When the wood veneer layer 3 is applied on the sub-layer, pressure is applied to the wood veneer layer 3 and/or to the substrate 1 by means of a pressing device. Preferably, heat is applied together with applying pressure. As shown in the FIGS. 1-5, the pressure may be applied by a continuous press 20, having an upper press belt 21 and a lower press belt 22. Pressure applied may be at least 25 bar, preferably about 30-60 bar, or about 35-50 bar. The pressure may be applied during at least 10 s, preferably during 20-40 s. The press 20 comprising e.g. either hot oil or electrical/induction heat may be heated in order to apply heat together with pressure or separated from pressure. A temperature of 100-250° C. may be applied. A temperature of at least 150° C., such as at least 180° C., may be applied. The temperature may depend on which binder is used. Also the temperature may depend on the speed of the production line in a continuous press or the press time of a static press.

When applying pressure, the wood veneer layer 3 is adhered to the substrate 1 by means of the binder in the sub-layer 2 such that a veneered building panel 10 is formed. During the pressing, the binder in the sub-layer 2 penetrates into the wood veneer layer 3. When the binder has hardened or cured the wood veneer layer 3 is fixed against the substrate 1.

A back side layer arrangement may be applied to a second surface 5 of the substrate 1, opposite the first surface 4. The back side layer arrangement is applied in order to provide the veneered building panel 10 with additional properties such as described below.

The back side layer arrangement includes a backing layer 7 and if desirable and necessary a binder to attach the backing layer 7 to the second surface 5 of the substrate 1. The back side layer arrangement may optionally include further layers or features (not illustrated) to create and adapt the back side layers of a desirable veneered building panel.

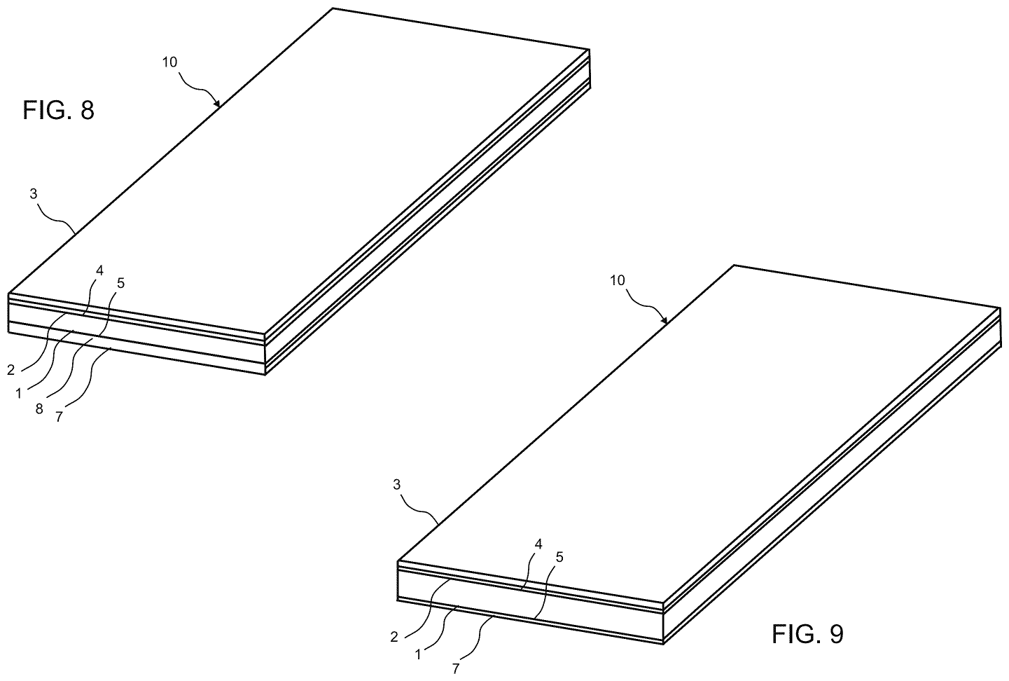

The backing layer 7 may be applied in combination with a sub-layer as described above with reference to the wood veneer layer 3. The sub-layer may comprise a binder, as described above with reference to the wood veneer layer 3. The binder in the back side layer arrangement may be different from the binder in the sub-layer 2 applied on the first surface 4 of the substrate 1. The binder in the back side layer arrangement may be the same as the binder in the sub-layer 2 applied on the first surface 4 of the substrate 1. After pressing, a veneered building panel is formed. The veneered building panel includes a front side arrangement including the sub-layer 2 and the wood veneer layer 3, and optionally a back side arrangement including at least the backing layer 7. Different types of pressed veneered building panel 10 are schematically illustrated in FIGS. 8-10.

The veneered building panel 10 may be processed from a larger panel board (not illustrated), e.g., by cutting the larger panel board into individual building panels.

The veneered building panel 10 may be provided with a mechanical locking system (not illustrated).

The veneered building panel 10 may be a floor panel, a furniture component, a worktop, a wall panel, a ceiling panel.

FIG. 8 shows a veneered building panel 10 comprising a substrate 1, a front side layer arrangement including a first sub-layer 2 applied on the first surface 4 of the substrate 1 and a wood veneer layer 3 applied on the first sub-layer 2. The veneered building panel further comprises a back side layer arrangement including a second sub-layer 8 applied on a second surface 5 of the substrate 1 opposite from the first surface 4 and a backing layer 7 applied on the second sub-layer 8. The backing layer of this embodiment may be a wood veneer backing layer 7. If it is, the wood veneer backing layer 7 of the back side layer arrangement preferably corresponds to the wood veneer layer 3 of the front side layer arrangement.

If the backing layer 7 is a wood veneer backing layer, it is adhered to the substrate 1 by means of a sub-layer 8 as described above with reference to the sub-layer 2 and wood veneer layer 3. The description and properties of the wood veneer layer 3 also applies to the wood veneer backing layer 7.

The backing layer 7 may in other embodiments be a cork veneer layer, a multiple paper layer, a polymer-based layer, a textile-based layer or similar.

These types of backing layers 7 may also be adhered to the substrate 1 by means of the same sub-layer 8 as described above.

The backing layer 7 may be a powder based backing layer being applied as a powder. The powder based backing layer may comprise wood particles such as lignocellulosic and/or cellulosic particles and a binder, such as a thermosetting binder. The powder may be coloured or uncoloured.

FIG. 9 shows a veneered building panel 10 comprising a substrate 1, a sub-layer 2 applied on the first surface 4 of the substrate 1, a wood veneer layer 3 applied on the sub-layer 2, and a backing layer 7 applied on the second surface 5 of the substrate 1. The backing layer 7 of this embodiment differs from the backing layers 7 presented with reference to FIG. 8.

The backing layer 7 may be an impregnated paper or an unimpregnated paper. The impregnated paper may be a resin impregnated paper, preferably impregnated with a thermosetting binder. The impregnated paper may be a printed paper, such as a decorative print and/or an informative print.

The backing layer 7 may be a lacquer, a varnish, an adhesive, a polymer-based sheet or foil, or a fabric, such as a woven or non-woven fabric.

The backing layer 7 may be applied without a sub-layer, e.g., when the backing layer 7 is a lacquer or a varnish.

When the veneered building panel 10 is configured to be used as a floor panel, it is configured to be laid on a building surface. The building surface may lead moisture to the veneered building panel. In order to prevent the veneered building panel from absorbing the moisture from the building surface, the backing layer 7 may form a moisture barrier, or diffusion barrier. The moisture barrier backing layer 7 may be vapour permeable in one direction, but not in an opposite direction. Alternatively, the moisture barrier backing layer 7 may be non-vapour permeable.

The backing layer 7 may be a balancing layer or counteracting layer applied in order to balance the veneered building panel or panel 10.

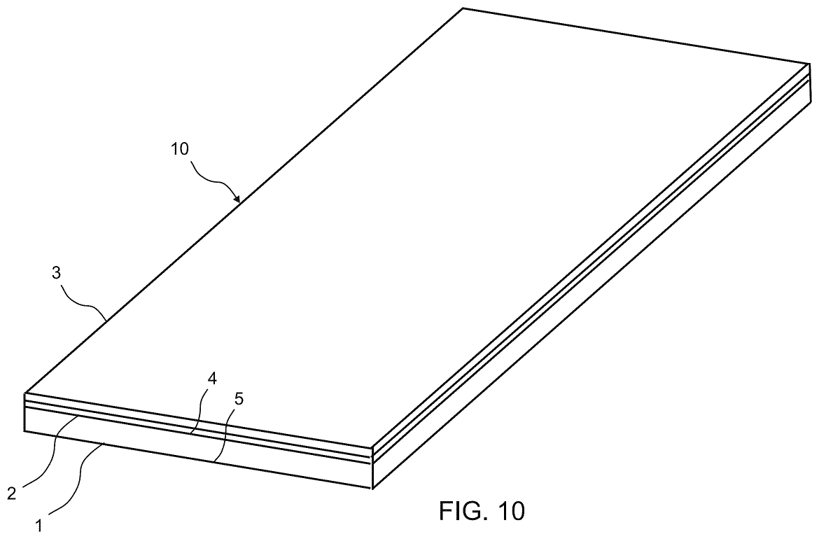

In one embodiment, shown in FIG. 10, there is no back side layer arrangement present of the veneered building panel 10. This veneered building panel 10 comprises a substrate 1 with a first surface 4 and a second surface 5. The veneered building panel 10 further comprises a sub-layer 2 provided on the first surface 4, and a wood veneer layer 3 provided on the sub-layer 2.

A method for producing a veneered building panel 10 will now be described with reference to FIGS. 1 and 6. The production method comprises providing 30 a substrate 1. The substrate 1 comprises a first surface 4 and a second surface 5 located opposite the first surface 4.

The substrate 1 is fed along a direction F into a production line comprising a sub-layer dispenser 14, a heating device 13, a dehydration device 17 and a pressing device 20.

In the sub-layer dispenser 14, a sub-layer 2 is applied 31 on the first surface 4 of the substrate 1. The sub-layer dispenser 14 is a scatter device 14 applying 31 the sub-layer 2 in powder form 6, by scattering.

Thereafter, the heating device 13 applies 32 heat on the sub-layer 2 in order to form a bond between the substrate 1 and the sub-layer 2.

A wood veneer layer 3 is applied 33 onto the sub-layer 2. Thereafter, the wood veneer layer 3 is dehydrated 34 by means of the dehydration device 17.

A backing layer 7 is applied 35 to the second surface 5 of the substrate 1. The backing layer 7 is either corresponding to the wood veneer layer 3, or it is different from the wood veneer layer 3.

A pressing device, embodied as a continuous press 20 having upper 21 and lower 22 belts, applies 36 pressure and heat to the substrate 1 and the thereon arranged wood veneer layer 3 and backing layer 7. Thus, a veneered building panel 10, e.g., as shown in FIG. 8 (backing layer corresponding to the wood veneer layer 3) or 9 (backing layer not corresponding to the wood veneer layer 3) is formed.

A method for producing a veneered building panel 10 will now be described with reference to FIGS. 2 and 7. The production method comprises providing 30 a substrate 1. The substrate 1 comprises a first surface 4 and a second surface 5 located opposite the first surface 4.

The substrate 1 is fed along a direction F into a production line comprising a sub-layer dispenser 14, a heating device 13, and a pressing device 20.

In the sub-layer dispenser 14, a sub-layer 2 is applied 31 on the first surface 4 of the substrate 1. The sub-layer dispenser 14 is a scatter device 14 applying 31 the sub-layer 2 in powder form 6, by scattering.

Thereafter, the heating device 13 applies 32 heat on the sub-layer 2 in order to form a bond between the substrate 1 and the sub-layer 2.

A dehydration device 17, located outside the production line, or not in-line the production line, dehydrates 34 a wood veneer layer 3.

Thereafter, the dehydrated wood veneer layer 3 is applied 33 onto the sub-layer 2.

A backing layer 7 is applied 35 to the second surface 5 of the substrate 1.

A pressing device, embodied as a continuous press 20 having upper 21 and lower 22 belts, applies 36 pressure and heat to the substrate 1 and the thereon arranged wood veneer layer 3 and backing layer 7. Thus, a veneered building panel 10, e.g., as shown in FIG. 8 or 9 is formed.

The method for producing a veneered building panel 10 shown in FIG. 3 corresponds mainly to the method described with reference to FIGS. 1 and 6. However, in the method embodied in FIG. 3, the sub-layer dispenser is a roller coater device 15 configured to apply the sub-layer 2 in liquid form. The method for producing a veneered building panel 10 shown in FIG. 3 results in a veneered building panel 10 according to FIG. 8 or 9.

The method for producing a veneered building panel 10 shown in FIG. 4 corresponds mainly to the method described with reference to FIGS. 1 and 6. However, in the method embodied in FIG. 4, the sub-layer dispenser is an extruder device 15 configured to apply the sub-layer 2 by extrusion. The method for producing a veneered building panel 10 shown in FIG. 4 results in a veneered building panel 10 according to FIG. 8 or 9.

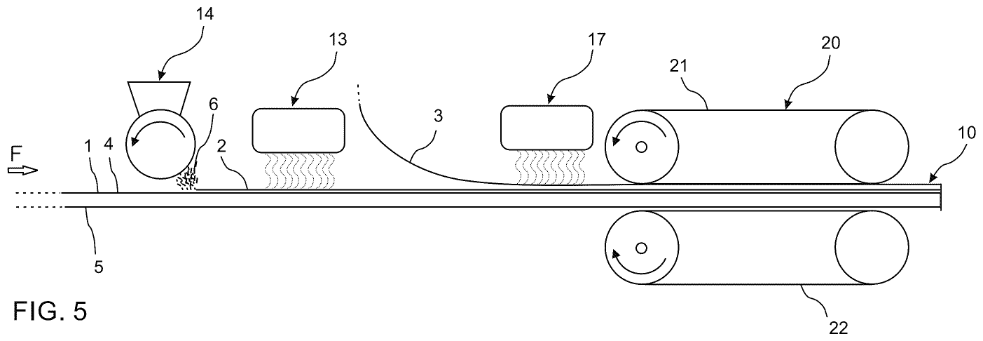

The method for producing a veneered building panel 10 shown in FIG. 5 corresponds mainly to the method described with reference to FIGS. 1 and 6. However, in the method embodied in FIG. 5, no backing layer is applied to the substrate. The method for producing a veneered building panel 10 shown in FIG. 5 results in a veneered building panel 10 according to FIG. 10.

The embodiments have been described in relation to a continuous press 20 having an upper press belt 21 and a lower press belt 22. In other embodiments, a static press may be used. A static press comprises an upper press plate and a lower press plate.

The dehydration of the wood veneer layer 3 may be performed by means of the pressing means of the pressing device such as press plate or press belt. The press plates may be brought together at a speed set such that the wood veneer layer is dehydrated before coming into contact with the press plate.

In the case of the pressing device being a belt press 20, the feed rate of the wood veneer layer 3 into the pressing device may be set such that the heat from the pressing device dehydrates the wood veneer layer 3 before it comes into contact with the upper press belt 21.

The features of the different embodiments may be combined in different ways as described above with reference to the drawings. E.g., the form in which the sub-layer 2 is applied, the application of heat for dehydrating the wood veneer layer, the type of press etc. may be combined in different ways, as the skilled person would understand from this description.

In the above description, the different types of products have been described with reference to floorings. However, the same material and problems applies for other types of building panels such as wall panels, ceiling panels, and for furniture components.

### EXAMPLES

In the following examples, a moisture content of oak veneer layers is determined by a gravimetric method by weighing an oak veneer layer before and after dehydration in an oven at 103° C. for 8 h. The moisture content (MC) is defined as (m−m_{dry})/m*100 wt. %.

In the examples, a veneered building panel is produced. The resulting veneered building panel is assessed with respect to visual and tactile appearance, and it is rated as “approved” or “not approved.” “Approved” being defined as a panel substantially free from visually and/or tactilely perceptible defects such as blisters and cracks in the veneer layer. “Not approved” being defined as a panel having visually and/or tactilely perceptible defects such as blisters and cracks in the veneer layer.

In the examples, where an IR lamp is used for either heating the sub-layer or heating the sub-layer and dehydrating the wood veneer layer, the IR lamp had a length of 28 cm and a width of 125 cm, and a maximum effect of 51 kW. The speed of which the substrate/panel was passed below the lamp was 5 m/min.

### Example 1

An HDF substrate is provided. A sub-layer comprising 450 g/m² of a cross-linking polyester based binder is applied in powder form on a first surface of the HDF substrate. The sub-layer is heated by means of an IR lamp set on 80% of the maximum effect, where the maximum effect is 51 kW. An oak veneer layer having a thickness of about 0.6 mm. and a moisture content according to Table 1 is provided. The oak veneer layer is applied on the sub-layer. The oak veneer layer is pressed on the HDF substrate with a pressure of 50 bar during 30 sec. at 180° C. in a press using electrical/induction heat.

The resulting product is a veneered building panel having blisters underneath and cracks in the oak veneer layer. All three veneered building panels in Example 1 are assessed to be “not approved” panels.

TABLE 1
No dehydration of the wood veneer layer prior
to pressing the veneered building panel.

| Reference | Moisture content (MC) in wt. %. | Result |
|---|---|---|
| 1 | 9.31 | not approved |
| 2 | 9.10 | not approved |
| 3 | 8.86 | not approved |

### Example 2

An HDF substrate is provided. A sub-layer comprising 450 g/m² of a cross-linking polyester based binder is applied in powder form on a first surface of the HDF substrate. The sub-layer is heated by means of an IR lamp set on 80% of the maximum effect, where the maximum effect is 51 kW. An oak veneer layer having a thickness of about 0.6 mm. is applied on the sub-layer. The oak veneer layer is dehydrated to a moisture content according to Table 2 by means of an IR lamp set on 80% of the maximum effect, where the maximum effect is 51 kW. The oak veneer layer is pressed on the HDF substrate with a pressure of 50 bar during 30 sec. at 180° C. in a press using electrical/induction heat. The resulting product is a veneered building panel substantially free of blisters and cracks in the veneer layer. All three veneered building panels in Example 2 are assessed to be “approved” panels.

TABLE 2
Dehydrated wood veneer layer with an IR
lamp set at 80% of the maximum effect.

| Reference | Moisture content (MC) in wt. %. | Result |
|---|---|---|
| 1 | 5.40 | approved |
| 2 | 5.31 | approved |
| 3 | 5.32 | approved |

### Example 3

An HDF substrate is provided. A sub-layer comprising 450 g/m² a cross-linking polyester based binder is applied in powder form on a first surface of the HDF substrate. The sub-layer is heated by means an IR lamp set on 80% of the maximum effect, where the maximum effect is 51 kW. An oak veneer layer having a thickness of about 0.6 mm. is placed in a climate chamber having a relative humidity of 40% for 24 h. The moisture content of the oak veneer layer is determined according to Table 3. The oak veneer layer is applied on the sub-layer. The oak veneer layer is pressed on the HDF substrate with a pressure of 50 bar during 30 sec. at 180° C. in a press using electrical/induction heat. The resulting product is a veneered building panel having blisters and cracks in the veneer layer. Both veneered building panels in Example 3 are assessed to be “not approved” panels.

TABLE 3
Dehydrated wood veneer layer in a climate
chamber having a relative humidity of 40%

| Reference | Moisture content (MC) in wt. %. | Result |
|---|---|---|
| 1 | 9.32 | not approved |
| 2 | 8.98 | not approved |

### Example 4

An HDF substrate is provided. A sub-layer comprising 450 g/m² a cross-linking polyester based binder is applied in powder form on a first surface of the HDF substrate. The sub-layer is heated by means of an IR lamp set on 80% of the maximum effect, where the maximum effect is 51 kW. An oak veneer layer having a thickness of about 0.6 mm. is placed in a climate chamber having a relative humidity of 30% for 24 h. The moisture content of the veneer layer is determined according to Table 4. The oak veneer layer is applied on the sub-layer. The oak veneer layer is pressed on the HDF substrate with a pressure of 50 bar during 30 sec. at 180° C. in a press using electrical/induction heat. The resulting product is a veneered building panel having blisters and cracks in the veneer layer. Thus, both veneered building panels in Example 4 are assessed to be “not approved” panels.

TABLE 4
Dehydrated wood veneer layer in a climate
chamber having a relative humidity of 30%

| Reference | Moisture content (MC) in wt. %. | Result |
|---|---|---|
| 1 | 8.26 | not approved |
| 2 | 7.70 | not approved |

### Example 5

An HDF substrate is provided. A sub-layer comprising 450 g/m² a cross-linking polyester based binder is applied in powder form on a first surface of the HDF substrate. The sub-layer is heated by means of an IR lamp set on 80% of the maximum effect, where the maximum effect is 51 kW. An oak veneer layer having a thickness of about 0.6 mm. is placed in a climate chamber having a relative humidity of 20% for 24 h. The moisture content of the veneer layer is determined according to Table 5. The oak veneer layer is applied on the sub-layer. The oak veneer layer is pressed on the HDF substrate with a pressure of 50 bar during 30 sec. at 180° C. in a press using electrical/induction heat. The resulting product is a veneered building panel substantially free from blisters and cracks in the veneer layer. Both veneered building panels in Example 5 are assessed to be “approved” panels.

TABLE 5
Dehydrated wood veneer layer in a climate
chamber having a relative humidity of 20%

| Reference | Moisture content (MC) in wt. %. | Result |
|---|---|---|
| 1 | 6.70 | approved |
| 2 | 6.12 | approved |

### Example 6

In this example, oak veneer with three types of structural features, in this case different types of grain in the wood, are tested. The oak veneers are dehydrated by means of an IR lamp. The IR effect of the IR lamp was set to 10, 20, 30, 40, 50, 60, 70 and 80% of the maximum effect (51 kW). The test was made to see if different structural features in the wood veneer layer is affected by the level of IR effect and how the finished veneered building panels are affected by the different structural features in the wood veneer layer. Thus, an HDF substrate is provided. A sub-layer comprising 450 g/m² a cross-linking polyester based binder is applied in powder form on a first surface of the HDF substrate. The sub-layer is heated by means of an IR lamp set on between 0 and 80% of the maximum effect, where the maximum effect is 51 kW, as seen in Table 6. An oak veneer layer having a thickness of about 6 mm. is applied on the sub-layer. The oak veneer layer is dehydrated by means of the IR lamp, set on an effect according to column 1 in Table 6, to a moisture content according to columns 1-3, respectively, in Table 6. The oak veneer layer is pressed on the HDF substrate with a pressure of 50 bar during 30 sec. at 180° C. in a press using electrical/induction heat.

The condition of the resulting product depends on the moisture content (MC) of the oak veneer layer. The condition of the product is determined as approved/not approved according to columns 1-3 in Table 6 where “approved” is a veneered building panel showing no defects such as blisters or cracks, and “not approved” is a veneered building panel having one or more defects. The result as presented below, showed that the defects were present in the pressed veneered building panels where the wood veneer layer, of all types, was dehydrated with an IR effect of between 0 and 60%. Although the present of defects where less occurring in the tests with higher effect such defects were non the less present. It is shown that the wood veneer layers having a moisture content of less than 5 wt. % in this specific test had no defects and therefore awarded the condition of “approved”.

TABLE 6

| | Reference 1: | Reference 2: | Reference 3: |
|---|---|---|---|
| | Moisture content | Moisture content | Moisture content |
| IR effect | (MC) in wt. %. | (MC) in wt. %. | (MC) in wt. %. |
| [% of maximum | (approved/not | (approved/not | (approved/not |
| effect] | approved) | approved) | approved) |
| 0 | 7.20 | 7.69 | 7.50 |
| | not approved | not approved | not approved |
| 10 | 7.22 | 6.71 | 6.85 |
| | not approved | not approved | not approved |
| 20 | 6.88 | 6.53 | 6.74 |
| | not approved | not approved | not approved |
| 30 | 6.61 | 5.72 | 5.72 |
| | not approved | not approved | not approved |
| 40 | 5.61 | 5.88 | 5.74 |
| | not approved | not approved | not approved |
| 50 | 5.84 | 5.59 | 5.65 |
| | not approved | not approved | not approved |
| 60 | 5.64 | 5.08 | 5.38 |
| | not approved | not approved | not approved |
| 70 | 5.45 | 4.76 | 5.10 |
| | not approved | approved | not approved |
| 80 | 4.56 | 3.79 | 4.93 |
| | approved | approved | approved |

### Example 7

An HDF substrate is provided. A sub-layer comprising 250 g/m² of a polyethylene terephthalate glycol (PET-G) sheet is positioned on the first surface of the HDF substrate. An oak veneer layer having a thickness of about 0.6 mm. and a moisture content according to Table 7 is provided. The oak veneer layer is applied on the sub-layer. The oak veneer layer is pressed on the HDF substrate with a pressure of 150 bar during 30 sec. at 180° C. in a press using electrical/induction heat.

The resulting product is a veneered building panel having blisters underneath and cracks in the oak veneer layer. All three veneered building panels in this Example are assessed to be “not approved” panels.

TABLE 7
No dehydration of the wood veneer layer prior
to pressing the veneered building panel.

| Reference | Moisture content (MC) in wt. %. | Result |
|---|---|---|
| 1 | 8.183 | not approved |
| 2 | 7.881 | not approved |
| 3 | 8.159 | not approved |

### Example 8

An HDF substrate is provided. A sub-layer comprising 250 g/m² of a polyethylene terephthalate glycol (PET-G) sheet is positioned on the first surface of the HDF substrate. An oak veneer layer having a thickness of about 0.6 mm. is applied on the sub-layer. The oak veneer layer is dehydrated to a moisture content according to Table 8 by means of an IR lamp set on 80% of the maximum effect, where the maximum effect is 51 kW and the conveyer speed is 5 m/min. The oak veneer layer is pressed on the HDF substrate with a pressure of 50 bar during 30 sec. at 180° C. in a press using electrical/induction heat. The resulting product is a veneered building panel substantially free of blisters and cracks in the veneer layer. All three veneered building panels in this Example are assessed to be “approved” panels.

TABLE 8
Dehydrated wood veneer layer with an IR
lamp set at 80% of the maximum effect.

| Reference | Moisture content (MC) in wt. %. | Result |
|---|---|---|
| 1 | 4.897 | approved |
| 2 | 5.126 | approved |
| 3 | 4.881 | approved |

### ITEMS

1. A method for producing a veneered building panel comprising:
providing a substrate (1),
applying a sub-layer (2) on a first surface (4) of the substrate (1),
applying a wood veneer layer (3) on the sub-layer (2), and
applying heat and pressure to form said veneered building panel,
wherein the method further comprises:
dehydrating the wood veneer layer (3), prior to applying heat and pressure to form said veneered building panel.
2. The method according to item 1, wherein dehydrating the wood veneer layer (3) comprises one or more of applying IR radiation, heat, microwaves and/or hot air to the wood veneer layer (3).
3. The method according to item 1 or 2, wherein the sub-layer (2) comprises a binder.
4. The method according to item 3, wherein the binder is a NAF binder.
5. The method according to item 3 or 4, wherein the binder comprises one or more of PVC, polyester, polyurethane or a combination thereof.
6. The method according to any of the preceding items, further comprising: heating the sub-layer (2) prior to applying the wood veneer layer (3) to the sub-layer (2).
7. The method according to item 6, wherein heating the sub-layer (2) comprises applying IR radiation on the sub-layer (2).
8. The method according to any of the preceding items wherein, dehydrating the wood veneer layer (3) comprises dehydrating the wood veneer layer to have a moisture content of less than 7 wt. %, or less than 5 wt. %.
9. The method according to any of the preceding items, wherein the substrate (1) is a wood-based board, optionally an MDF or HDF board.
10. The method according to any of the preceding items, wherein an applied dehydration effect, for dehydrating the wood veneer layer (3), is proportional to a thickness of the wood veneer layer (3).
11. The method according to any of the preceding items, further comprising:
applying a backing layer (7) to a second surface (5) of the substrate (1) opposite the first surface (4) on which the sub-layer (2) is applied.
12. The method according to item 11, wherein the backing layer (7) is configured to form a moisture barrier.
13. A veneered building panel (10), comprising:
a substrate (1),
a front side layer arrangement arranged on a first surface (4) of the substrate (1), wherein the front side layer arrangement comprises
   a sub-layer (2), and
   a wood veneer layer (3) wherein the sub-layer (2) is arranged between the substrate (1) and the wood veneer layer (3),
a back side layer arrangement arranged on a second surface (5) of the substrate (1) opposite the front side layer arrangement, wherein the back side layer arrangement comprises
   a backing layer (7),
wherein the sub-layer (2) comprises a NAF-binder, and
wherein the back side layer arrangement is different from the front side layer arrangement.
14. The veneered building panel according to item 13, wherein the binder comprises one or more of PVC, polyester, polyurethane or a combination thereof.
15. The veneered building panel according to item 13 or 14, wherein the wood veneer layer (3) had a moisture content of less than 7 wt. %, or less than 5 wt. % prior to forming said veneered building panel.
16. The veneered building panel according to any of the items 13-15, wherein a thickness of the wood veneer layer (3) is 0.2-2.5 mm., or 0.3-2.0 mm.
17. The veneered building panel according to any one of the items 13-16, wherein the backing layer (7) comprises one of a lacquer, a varnish, an adhesive, a polymer-based sheet or foil, impregnated paper, or unimpregnated paper, a powder layer, optionally coloured, or a fabric, such as a woven or non-woven fabric.
18. The veneered building panel according to any of the items 13-17, wherein the backing layer (7) is configured to form a moisture barrier.

1. A method for producing a veneered building panel comprising:
providing a substrate,
applying a sub-layer on a first surface of the substrate,
applying a wood veneer layer on the sub-layer, and
applying heat and pressure to form said veneered building panel,
wherein the method further comprises:
dehydrating the wood veneer layer, prior to applying heat and pressure to form said veneered building panel,
wherein dehydrating the wood veneer layer comprises applying one or more of IR radiation, heat, microwaves and/or hot air to the wood veneer layer; and wherein the sub-layer comprises a no added formaldehyde binder.

2. The method according to claim 1, wherein dehydrating the wood veneer layer comprises dehydrating the wood veneer layer after applying the wood veneer layer on the sub-layer.

3. The method according to claim 1, wherein the sub-layer is applied in powder form, as a sheet, in liquid form, and/or as granulates.

4. The method according to claim 1, wherein the sub-layer is applied in powder form.

5. The method according to claim 1, wherein the binder comprises one or more of PVC, polyester, polyurethane, or a combination thereof.

6. The method according to claim 1, further comprising:
heating the sub-layer prior to applying the wood veneer layer to the sub-layer.

7. The method according to claim 6, wherein heating the sub-layer comprises applying IR radiation on the sub-layer.

8. The method according to claim 1, further comprising a step of cooling the substrate, sub-layer and wood veneer layer prior to applying heat and pressure to form said veneered building panel.

9. The method according to claim 1, wherein dehydrating the wood veneer layer comprises dehydrating the wood veneer layer to have a moisture content of less than 7 wt. %.

10. The method according to claim 1, wherein the substrate is a wood-based board, optionally an MDF or HDF board.

11. The method according to claim 1, wherein an applied dehydration effect, for dehydrating the wood veneer layer, is proportional to a thickness of the wood veneer layer.

12. The method according to claim 1, further comprising:
applying a back side layer arrangement comprising a backing layer to a second surface of the substrate opposite the first surface on which the sub-layer is applied.

13. The method according to claim 12, wherein the back side layer arrangement comprises a binder configured to attach the backing layer to a second surface of the substrate, and wherein the binder in the back side layer is the same as the binder in the sub-layer.

14. The method according to claim 12, wherein the backing layer is configured to form a moisture barrier.

15. A veneered building panel produced with the method according to claim 1.

16. A veneered building panel, comprising:
a substrate,
a front side layer arrangement arranged on a first surface of the substrate, wherein the front side layer arrangement comprises
a sub-layer, and
a wood veneer layer wherein the sub-layer is arranged between the substrate and the wood veneer layer,
a back side layer arrangement arranged on a second surface of the substrate opposite the front side layer arrangement, wherein the back side layer arrangement comprises
a backing layer,
wherein the sub-layer comprises a no added formaldehyde binder, and wherein the back side layer arrangement is different from the front side layer arrangement.

17. The veneered building panel according to claim 16, wherein the binder comprises one or more of PVC, polyester, polyurethane or a combination thereof.

18. The veneered building panel according to claim 16, wherein the wood veneer layer had a moisture content of less than 7 wt. %, or less than 5 wt. % prior to forming said veneered building panel.

19. The veneered building panel according to claim 16, wherein a thickness of the wood veneer layer is 0.2-2.5 mm.

20. The veneered building panel according to claim 16, wherein the backing layer comprises one of a lacquer, a varnish, an adhesive, a polymer-based sheet or foil, impregnated paper, or unimpregnated paper, a powder layer, optionally coloured, or a fabric.

21. The veneered building panel according to claim 16, wherein the backing layer is configured to form a moisture barrier.
